(19) United States
(12) Patent Application Publication
(10) Pub. No.: US 2017/0154521 A1
(43) Pub. Date: Jun. 1, 2017

(54) METHODS AND SYSTEMS FOR PROVIDING PERSONAL EMERGENCY ALERTS AND CONTEXT AWARE ACTIVITY NOTIFICATIONS

(71) Applicant: Carlos Guillermo Zamorano-Larrate, Whitby (CA)

(72) Inventor: Carlos Guillermo Zamorano-Larrate, Whitby (CA)

(21) Appl. No.: 15/365,021

(22) Filed: Nov. 30, 2016

Related U.S. Application Data
(60) Provisional application No. 62/260,957, filed on Nov. 30, 2015.

(51) Int. Cl. G08B 25/01; H04W 8/00; G08B 25/10

(52) U.S. Cl. CPC G08B 25/016; G08B 25/10; H04W 8/005

(57) ABSTRACT

Method and system provide personal emergency alert to remote computing device from wearable device having sensor(s), microcontroller, and communication interface. The wearable device receives sensor input signal(s). The microcontroller runs computer instructions to: (i) process the sensor input signal(s); and (ii) determine whether a personal emergency event has occurred, and, if so, generate a personal emergency output signal to send through the communication interface to a host computing device using short range radio communication. The host computing device sends the personal emergency output signal to remote computing device over long range radio communication. Method and system also provide context aware activity notification to a remote computing device upon receiving activity confirmation signal from a wearable device. Notification is sent through a host computing device with context aware activity notification software having data harvesting module, user definition and preferences setting module, environmental input processing module, learning module, and communication module.

### FIELD

The embodiments described herein relate to methods and systems for providing a personal emergency alert or a context aware activity notification.

### SUMMARY

In one aspect, in at least one embodiment described herein, there is provided a method for providing a personal emergency alert to a remote computing device from a wearable device having at least one sensor, a microcontroller, and a communication interface, all operatively coupled to each other and a host computing device, the method comprising:
receiving at the wearable device at least one sensor input signal from the at least one sensor;
running a plurality of computer instructions on the microcontroller to:
   (i) process the at least one sensor input signal; and
   (ii) determine whether a personal emergency event has occurred, and, if so, generate a personal emergency output signal;
operating the microcontroller to send the personal emergency output signal through the communication interface to the host computing device using short range radio communication; and
operating the host computing device to send the personal emergency output signal to the remote computing device over long range radio communication.

In another aspect, in at least one embodiment described herein, there is provided a personal emergency alert system, the system comprising:
a wearable device having at least one sensor, a microcontroller, and a communication interface, all operatively coupled to each other;
a host computing device; and
a remote computing device;
wherein
   the wearable device receives at least one sensor input signal from the at least one sensor;
   the microcontroller runs a plurality of computer instructions to:
      (i) process the at least one sensor input signal; and
      (ii) determine whether a personal emergency event has occurred, and, if so, generate a personal emergency output signal to send through the communication interface to the host computing device using short range radio communication; and
   the host computing device sends the personal emergency output signal to the remote computing device over long range radio communication.

In another aspect, in at least one embodiment described herein, there is provided a method for providing a context aware activity notification to a remote computing device upon receiving an activity confirmation signal from a wearable device, the method comprising:
providing a context aware activity notification software for installation on a host computing device, the context aware activity notification software comprising:
   a data harvesting module that receives a plurality of environmental inputs from a plurality of sensors;
   a user definition and preferences setting module that enables a user to define and store in memory a plurality of conditional activities, each conditional activity comprising an activity, at least one condition associated with the activity, and a link to a remote computing device to perform the activity;
   an environmental input processing module that monitors the plurality of environmental inputs and runs a rules matching algorithm that ranks the plurality of conditional activities, assigning and storing in memory a first rank for each conditional activity, based on comparison of the at least one condition associated with the activity and the plurality of environmental inputs;
   a learning module that
      receives user input that ranks a subset of conditional activities in the plurality of conditional activities, assigning and storing in memory a second rank for each conditional activity in the subset of conditional activities based on user input; and
      if the second rank is different from the first rank, stores in a knowledge base the conditional activity in connection with the first rank and the second rank; and
   a communication module that
      receives the activity confirmation signal from the wearable device;
      sorts the plurality of conditional activities based on rank; generates a context aware activity notification message based on the conditional activity having the highest rank;
      and
      sends the context aware activity notification message to the remote computing device corresponding to the conditional activity having the highest rank, to perform the conditional activity having the highest rank.

In another aspect, in at least one embodiment described herein, there is provided a context aware activity system, the system comprising:
a wearable device to receive input from a user and generate an activity confirmation signal;
a plurality of remote computing devices; and
a host computing device having a context aware activity notification software installed and running on it, the context aware activity notification software comprising:
   a data harvesting module that receives a plurality of environmental inputs from a plurality of sensors;
   a user definition and preferences setting module that enables the user to define and store in memory a plurality of conditional activities, each conditional activity comprising an activity, at least one condition associated with the activity, and a link to a remote computing device to perform the activity;
   an environmental input processing module that monitors the plurality of environmental inputs and runs a rules matching algorithm that ranks the plurality of conditional activities, assigning and storing in memory a first rank for each conditional activity, based on comparison of the at least one condition associated with the activity and the plurality of environmental inputs;
   a learning module that
      receives user input that ranks a subset of conditional activities in the plurality of conditional activities, assigning and storing in memory a second rank for each conditional activity in the subset of conditional activities based on user input; and
      if the second rank is different from the first rank, stores in a knowledge base the conditional activity in connection with the first rank and the second rank; and
   a communication module that
      receives the activity confirmation signal from the wearable device;
      sorts the plurality of conditional activities based on rank;
      generates a context aware activity notification message based on the conditional activity having the highest rank;
      and
      sends the context aware activity notification message to the remote computing device corresponding to the conditional activity having the highest rank, to perform the conditional activity having the highest rank.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of a personal emergency alert system in accordance with at least one embodiment;

FIG. 2 is a block diagram a personal emergency alert system in a bullet proof vest with a resistive sensor in accordance with at least one embodiment;

FIG. 3 is a block diagram of the bullet proof vest of FIG. 2 in accordance with at least one embodiment;

FIGS. 4A, 4B and 4C are waveform diagrams of output from the resistive sensor and through each filter in the microcontroller of FIG. 3 in accordance with at least one embodiment;

FIG. 5 is a block diagram a the personal emergency alert system in a bullet proof vest with a plurality of accelerometers in accordance with at least one embodiment;

FIG. 6 is a block diagram of the bullet proof vest of FIG. 5 in accordance with at least one embodiment;

FIG. 7 is a block diagram of a personal emergency alert system in a weapon engagement detection device in accordance with at least one embodiment;

FIG. 8 is a block diagram of a context aware activity system in accordance with at least one embodiment;

FIG. 9 is a block diagram of a context aware activity system in accordance with at least one embodiment;

FIG. 10 is a diagram of a resistive membrane sensor in accordance with at least one embodiment;

FIG. 11 is a diagram of an assembled resistive membrane sensor in accordance with at least one embodiment;

FIG. 12 is a diagram of a front cross-section view of a bullet proof vest with the resistive membrane sensor of FIG. 11 in accordance with at least one embodiment;

FIG. 13 is a diagram of a side cross-section view of the bullet proof vest of FIG. 12 in accordance with at least one embodiment;

FIGS. 14A-14B is a diagram showing the front and the back views, respectively, a bullet proof vest with accelerometers in accordance with at least one embodiment;

FIG. 15 is a diagram showing X-Y-Z planes in accordance with at least one embodiment; and

FIGS. 16 and 17 are flowcharts showing a method to reduce power consumption of a wearable device of of an emergency alert system in accordance with at least one embodiment.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity.

### DESCRIPTION OF VARIOUS EMBODIMENTS

The various embodiments described herein generally relate to methods (and associated systems configured to implement the methods) for providing personal emergency alert.

Various apparatuses or methods will be described below to provide an example of an embodiment of the claimed subject matter. No embodiment described below limits any claimed subject matter and any claimed subject matter may cover methods or apparatuses that differ from those described below. The claimed subject matter is not limited to apparatuses or methods having all of the features of any one apparatus or methods described below or to features common to multiple or all of the apparatuses or methods described below. It is possible that an apparatus or methods described below is not an embodiment that is recited in any claimed subject matter. Any subject matter disclosed in an apparatus or methods described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal or a mechanical element depending on the particular context. Furthermore, the term “communicative coupling” indicates that an element or device can electrically, optically, or wirelessly send data to another element or device as well as receive data from another element or device.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware, software, or both hardware and software. In some cases, the example embodiments described herein may be implemented, at least in part, by using one or more computer programs, executing on one or more programmable devices comprising at least one processing element or executing on one or more integrated circuit elements, and a data storage element (including volatile and non-volatile memory and/or storage elements). These devices may also have at least one input device (e.g. a microphone, sensor, keyboard, mouse, a touchscreen, and the like), and at least one output device (e.g. a display screen, a speaker, a printer, a wireless radio, and the like) depending on the nature of the device.

It should also be noted that there may be some elements that are used to implement at least part of one of the embodiments described herein that may be implemented via software that is written in a high-level procedural language such as object oriented programming. Accordingly, the program code may be written in C, C⁺⁺, Java, or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc, Secure Digital (SD) card, and micro Secure Digital (SD) card) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, Internet transmissions (e.g. downloads), media, digital and analog signals, and the like. The computer useable instructions may also be in various formats, including compiled and non-compiled code.

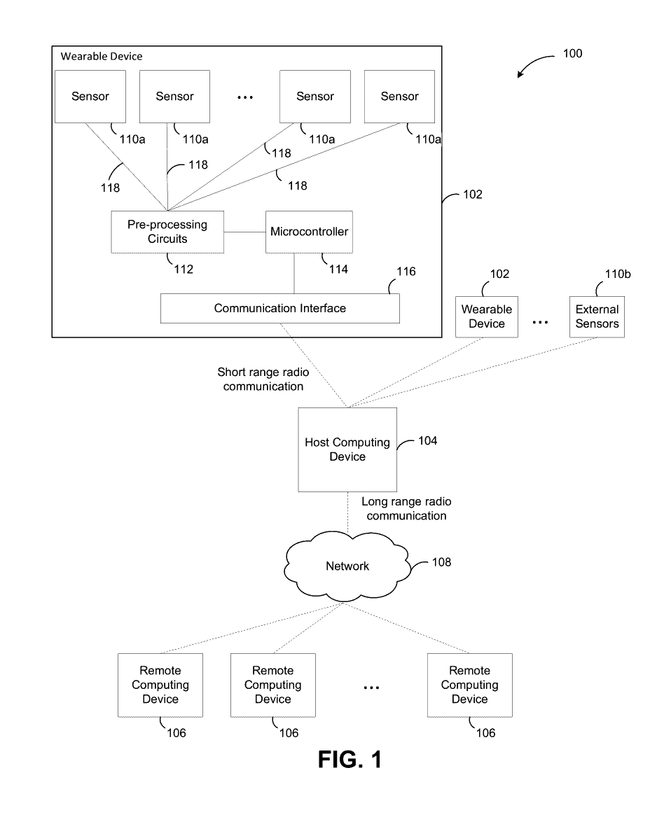

Reference is first made to FIG. 1, which shows a block diagram of components interacting as part of a personal emergency alert system 100 in accordance with an example embodiment. As shown in FIG. 1, personal emergency alert system 100 can include one or more wearable devices 102, a host computing device 104 (e.g., smartphone, smartwatch, tablet, or 2-way radio in short range) in short range radio communication with the one or more wearable devices 102, and one or more remote computing devices 106 (e.g., back-end server, monitoring station, phone, or PC) connected to the host computing device 104 through long range communication through a communication network 108.

Network 108 may be any network or network component capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.), and others, including any combination of these.

In some embodiments, the wearable device can be a bullet proof vest. In some other embodiments, the wearable device can be a weapon holder capable of detecting weapon draw and/or engagement. As shown in FIG. 1, the wearable device can be any device worn by a person that comprises one or more internal sensors 110a or external sensors 110b, pre-processing circuits 112, a microcontroller 114, and a communication interface 116. In some embodiments, the pre-processing circuits 112 can condition analog sensor output signals 118 and/or convert the analog signals 118 to digital signals. The microcontroller 114 can take one or more pre-processed input signals, run an event detection algorithm on the signal(s) 118, and generate an output signal indicating a detected event of interest.

The communication interface 116 may be used to transmit and receive data using wired or wireless communication with nearby devices such as the host computing device 104. For wireless communication, the communication interface 116 may be equipped with the radio frequency (RF) circuits components for transmitting and receiving RF signals such as controllers, oscillators, power amplifiers, antennas, signal processors and modulators to generate signals and receive signals that correspond to known short range wireless protocols, e.g., Bluetooth.

The wearable device 102 can communicate the detected event of interest through the communication interface 116 to the host computing device 104, which can in turn relay the detected event of interest to a the remote computing device 106 via the communication network 108. The remote computing device 106 can in turn generate a warning event to a monitoring station or send a message to notify a set of pre-defined recipients of the occurrence of the event of interest.

In some embodiments, the sensors 110a of the bullet proof vest can be configured to detect an object (bullet) impact, punches and other violent mechanical events. These sensors can be configured to detect the physical manifestations of violent mechanical events such as vibrations, shock waves or sudden accelerations. The microcontroller 114 built into the vest can process the signals 118 produced by the sensors 110a, decide if it is an event of interest (for example, real bullet impact or punch) and then operate the communication interface 116 to wirelessly transmit a signal indicating that event to the host computing device 104 such as a smartphone, computer, smart radio or other device that can relay this information through the communication network 108 to notify a remote recipient that a critical event has occurred and that help is needed.

In some other embodiments, the wearable device 102 may be configured for two-way communication, that is, receive communication from the host computing device 104. For example, the software or firmware operating in the various components may be updated wirelessly. The new firmware data may be transmitted wirelessly to the wearable 102 by the host computing device 104 instead of using a wired connection.

In some embodiments, the bullet proof vest can be instrumented with two types of sensors to detect an event of interest. For example internal sensors 110a and external sensors 110b may be used, in which the external sensor 110b is a microphone capable of detecting sounds including those associated with gunshots. Internal sensors may be a pressure sensor capable of detecting the impact of a bullet to the vest. An event of interest can thus be characterized as a high intensity but short lifetime pressure event on a small area of the vest's surface, for example the impact of a bullet or a punch.

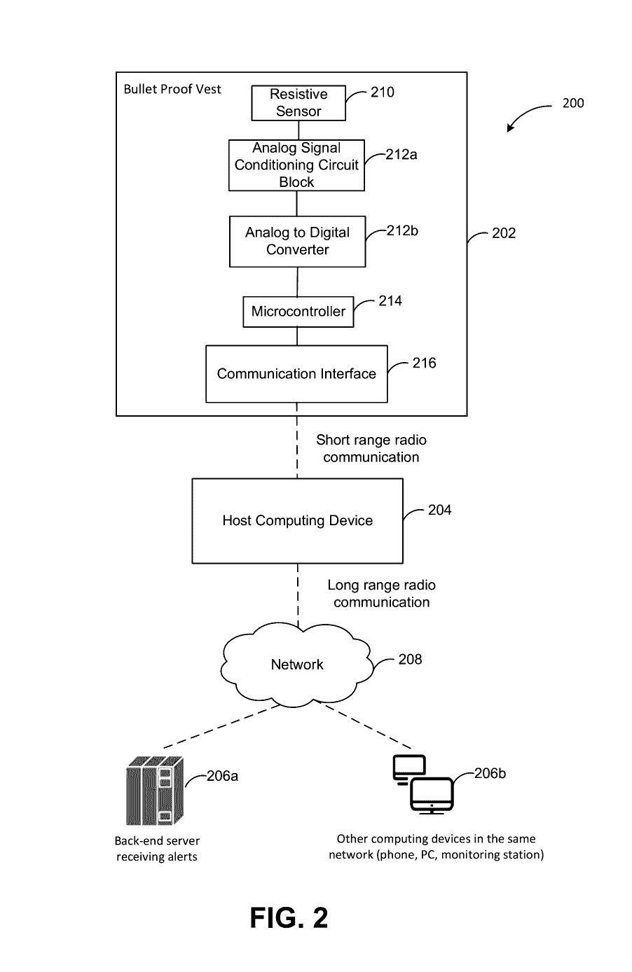

FIG. 2 show a diagram of an example embodiment of the personal emergency alert system on a bullet proof vest 202 with a resistive membrane sensor 210. Elements corresponding to those described previously with respect to FIG. 1 shall be numbered in a similar manner.

In some embodiments, a resistive membrane sensor 210 can be installed inside the bullet proof vest covering the entire vest. This resistive membrane sensor 210 can use an electrically conductive membrane that can vary its resistance value depending on the amount of pressure or bending experienced.

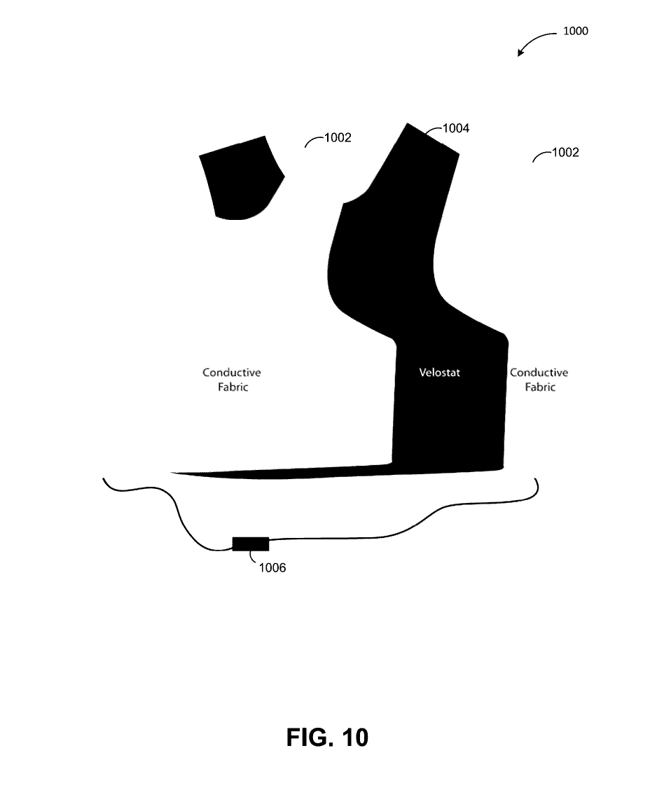

For example, Velostat™ is a packaging material made of a polymeric foil impregnated with carbon black to make it electrically conductive. The resistance of the Velostat material can change, for example, under flexion or pressure. The measurable resistance when pressure is applied can be lower than when no pressure is applied, so the resistance reading can be used to indicate when pressure is applied on or removed. Soft&Safe™ is a conductive shielding fabric made with a blend of natural materials: 22% cotton, 42% bamboo fiber, and 36% Silver. The fabric is washable, and cuts and sews like ordinary cotton fabric. The surface has high electrical conductivity (<1 Ohm per sq) and greater than 50 dB attenuation. Layering the Velostat and Soft&Safe material in the manner shown in FIG. 10 may produce a vest with the desirable resistive membrane sensor 1000 with the desired electrical properties. FIG. 10 shows the different layers of an example implementation of the resistive membrane sensor 1000 using Velostat 1004 and Soft&Safe 1002. The conductive fabric (Soft&Safe) layer may form two terminals upon which the resistance can be measured using an appropriate resistance measuring device 1006. In some embodiments, the resistance measuring device 1006 may include a power source such as a battery to allow continuous measurement of the resistance and to generate an analog signal that corresponds to the measured resistance.

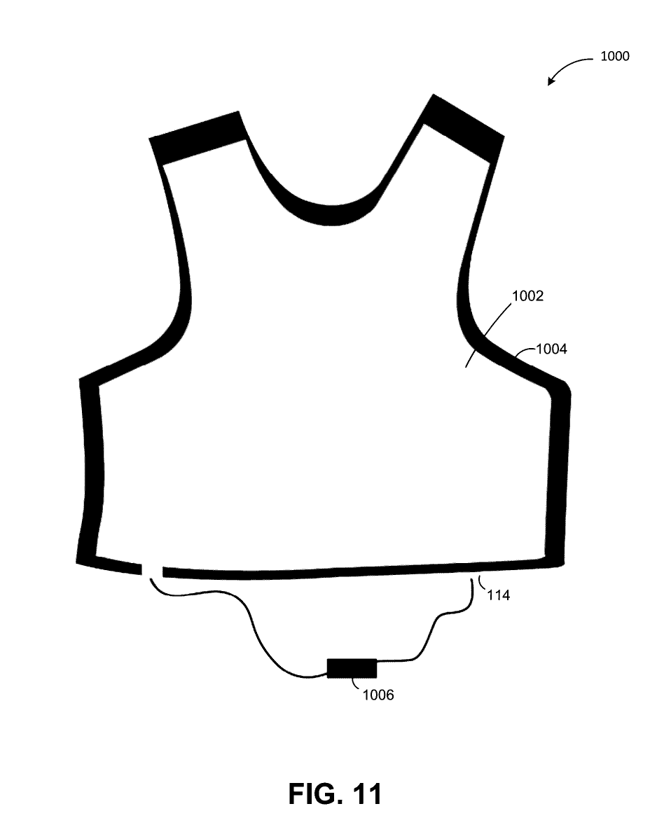

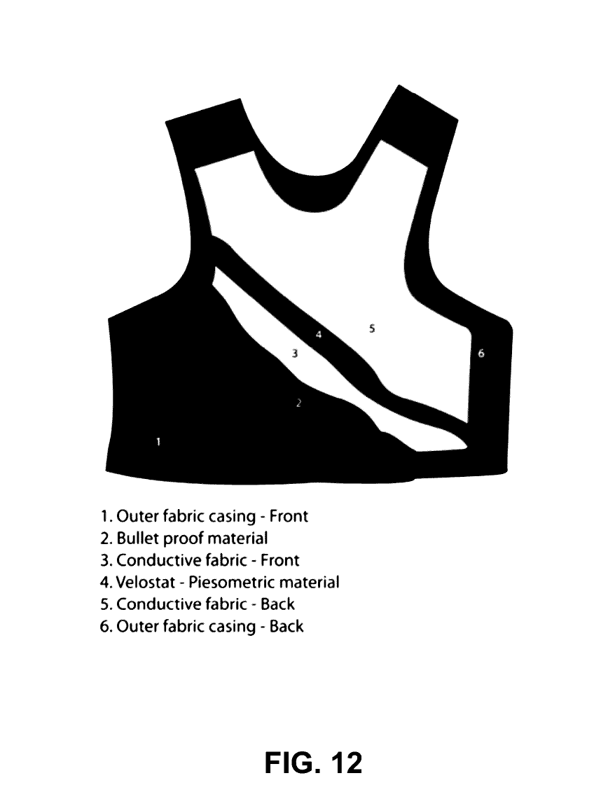

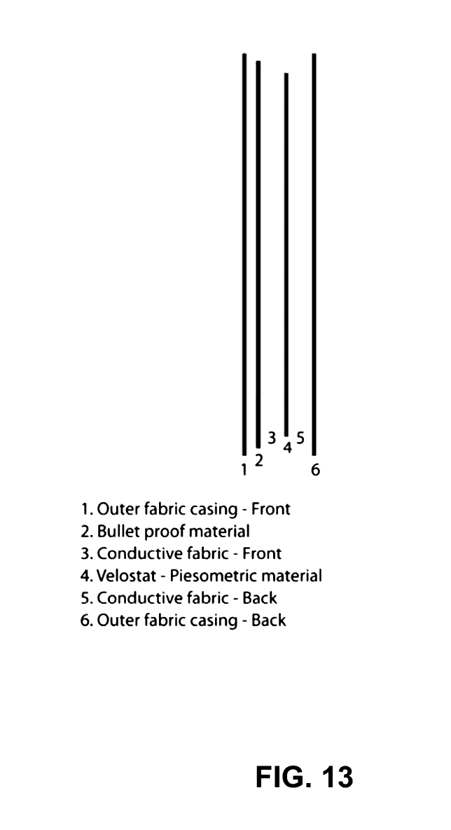

FIG. 11 shows an example implementation of a completed resistive membrane sensor 1000 using Velostat™ and Soft&Safe™ materials. FIG. 12 shows a front cross-section view of an example implementation of the bullet proof vest with the resistive membrane sensor 1000 of FIGS. 10 and 11. FIG. 13 shows a side cross-sectional view of an example implementation of the bullet proof vest with resistive membrane sensor 1000 of FIGS. 10 and 11.

In some embodiments, the resistive membrane sensor 1000 can produce a continuous analog signal (e.g. every ˜3 milliseconds or less) corresponding to the varying resistance value as a result of varying pressure and/or bending experienced by the membrane. Under normal movement of a person wearing the vest, the output signal from the resistive membrane sensor 1000 generally vary slowly. If a bullet or punch impacts the person wearing the vest, however, the membrane can experience a significant pressure or bend over a very short time. Therefore, the resistance measurement device 1006 may output a signal indicating a much higher amplitude and faster variation in the corresponding resistance value with respect to time.

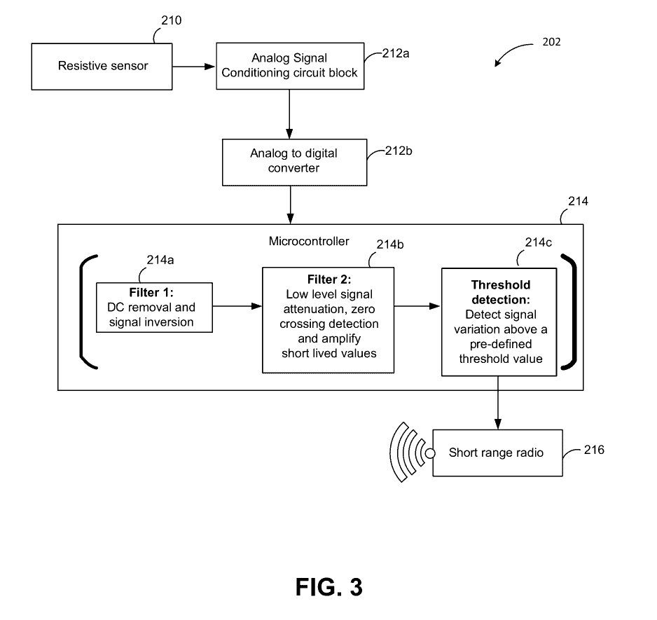

As shown in FIG. 2 and in more detail in FIG. 3, the analog signal produced by the resistive sensor 210 may first be received by an Analog Signal Conditional Circuit Block 212a. In some embodiments, the Analog Signal Conditional Circuit Block 212a can use a voltage divider with a minimum total resistance value of 5 Ohms (Ω), thus making the total current circulating the circuit lower, which can help reduce power consumption of the overall system. If the wearable device 202 is powered by a portable power source such as a battery, such a configuration may help extend the useful life of the battery and therefore the length of time the wearable device 202 can be used. Since the current produced is low, the output signal can be small in amplitude—varying between 5-50 millivolts (mV), for example. In some cases the Analog Signal Conditional Circuit Block 212b can further include a high gain amplifier (e.g. ˜100× gain) to amplify the received signal as part of the signal conditioning step. The conditioned signal may then be converted into a digital signal using an Analog to Digital Converter 212b.

It may be noted that inclusion of a the high gain amplifier may be advantageous so that the analog signal may be detectable by the Analog to Digital Converter 212b. The digitized sensor signal may then be provided to the Microcontroller 214, for further processing. The Microcontroller 214 can be implemented using a processor, an Application Specific Integrated Circuit (ASIC), Field Programmable Gate Array (FPGA) or Digital Signal Processor (DSP) that can provide sufficient processing power for the operation.

FIG. 3 shows that the Microcontroller 214 can be configured to implement two digital filters to perform digital signal processing (DSP) of the digitized sensor signal. In the present embodiment, the first digital filter can be a DC offset filter 214a to remove the DC offset and invert the digitized sensor signal. The second digital filter can be a high-pass filter 214b to remove the low frequency components of the input signal (e.g. signals that are generated when the vest is worn normally). In some embodiments, the cut-off frequency of the high-pass filter may be 45 Hz.

Removal of the DC component may permit optimal use of the dynamic range of a discrete filter (e.g. the high pass filter 214b) implemented on a computing device such as the microcontroller 214. As such, there may be advantages in the ordering of the filters used in the Microcontroller 214. For example, processing the digitized sensor signal with the DC offset filter 214a first may allow the full resolution of the second digital filter to be utilized. In the case of the high-pass filter 214b of FIG. 3, DC removal prior to filtering may prevent the filtered signal from being clamped or clipped by the filter.

The second digital filter can further be implemented to detect zero crossings, and to amplify the high frequency components of the digitized input signal to identify potential events of interest, for example, a bullet impact. The filter can be configured based on the nature of a bullet hit, which may be determined empirically by examining various characteristics including, but not limited to, the waveform shape, and various parameters such as the amplitude and frequency response, produced from a known bullet impact. Other types of impacts may similarly be characterized using amplitude and frequency response and appropriate thresholds may then be established. In addition, the Microcontroller 214 can also store a predefined threshold value in a threshold detection module 214c, and output a personal emergency alert only when the detected signal surpasses the threshold value.

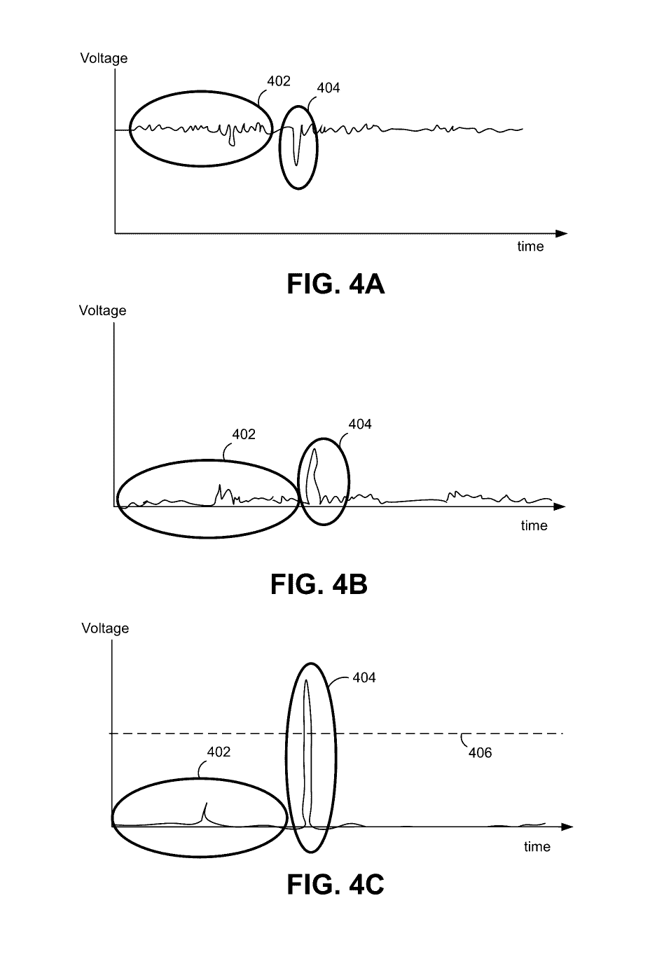

The combination of filters shown in FIG. 3 can allow improved identification of events of interest such as a bullet impact versus natural movements of a person wearing the vest. Referring now to FIGS. 4A-4C shown therein are example sensor output waveforms representative of normal movement and a bullet impact as they are originally produced from the resistive sensor 210 and through each filter implemented in the microcontroller 214.

In FIG. 4A, the waveform portion 402 may be regarded as corresponding to normal movement of a person wearing the vest while waveform portion 404 may be regarded as corresponding to high speed and/or force impact on the vest. It may be noted from FIG. 4A that the DC level of the waveform is at a voltage level donated by ‘A’. Furthermore, since the resistance is said to reduce when pressure is applied to the resistive sensor, the measured voltage across the sensor would correspondingly decrease.

FIG. 4B shows the two portions of the waveform after it has been filtered by the first digital filter, such as a DC offset filter 214a, which removes DC offset and inverts the signal so that the voltage signal variation varies positively rather than negatively when an event of interest occurs. FIG. 4C shows the two portions of the waveform after it has been filtered by the second digital filter, the high pass filter 214b, which removes low frequency components and amplifies the portion of high frequency and short duration.

It may be noted from FIG. 4C that the high pass filter may attenuate the portion of the waveform corresponding to normal movement since such a signal may be slow moving (i.e. low frequency), while amplifying or emphasizing portions of the signal that are of high intensity and short duration (i.e. high frequency). A Threshold level 406 can be established using the threshold detection module 214c so that low amplitude signals that generally correspond to normal movement are excluded while high amplitude signals corresponding to events of interest are detected.

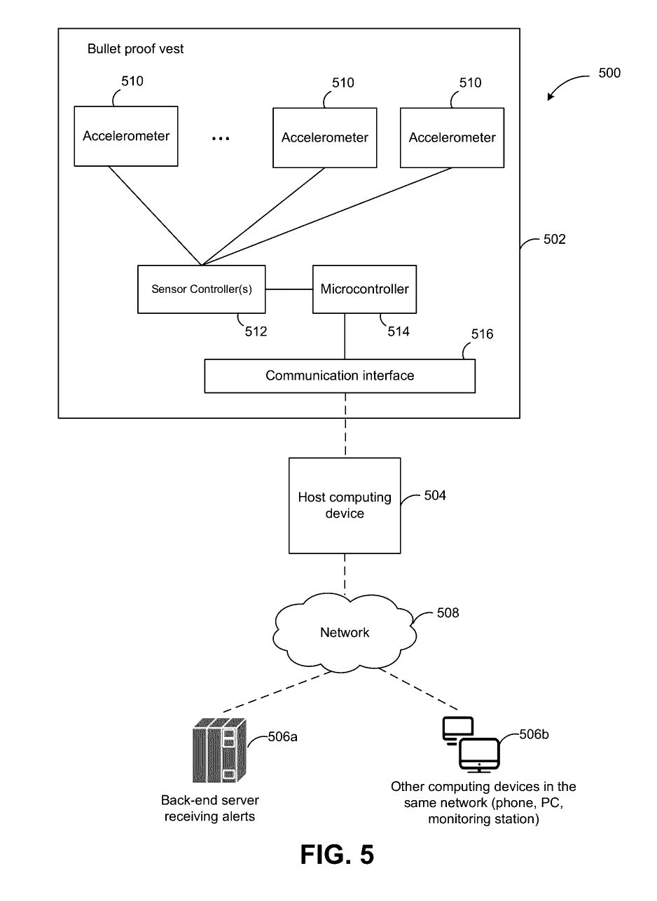

FIG. 5 illustrates another example embodiment of the personal emergency alert system built into on a bullet proof vest. Elements corresponding to those described previously with respect to FIG. 2 shall be numbered in a similar manner. Similar to the bullet proof vest of FIGS. 2 and 3, instead of resistive sensors, a plurality of accelerometers may be employed to detect impact events.

In some embodiments, a set of multi-dimensional accelerometers 510 can be installed inside the vest 502. When the vest 502 is hit by a bullet or punch or high impact, a mechanical wave due to the impact may propagate from the impact point throughout the surface material of the vest 502, and the motion due to the wave can be detected by the accelerometers 510. Each of the accelerometers 510 can produce an output proportional to the localized force experienced the accelerometer. It may therefore be noted that by installing a series of accelerometers throughout the vest 502, the location of impact may be determined by examining the signals produced by each accelerometer.

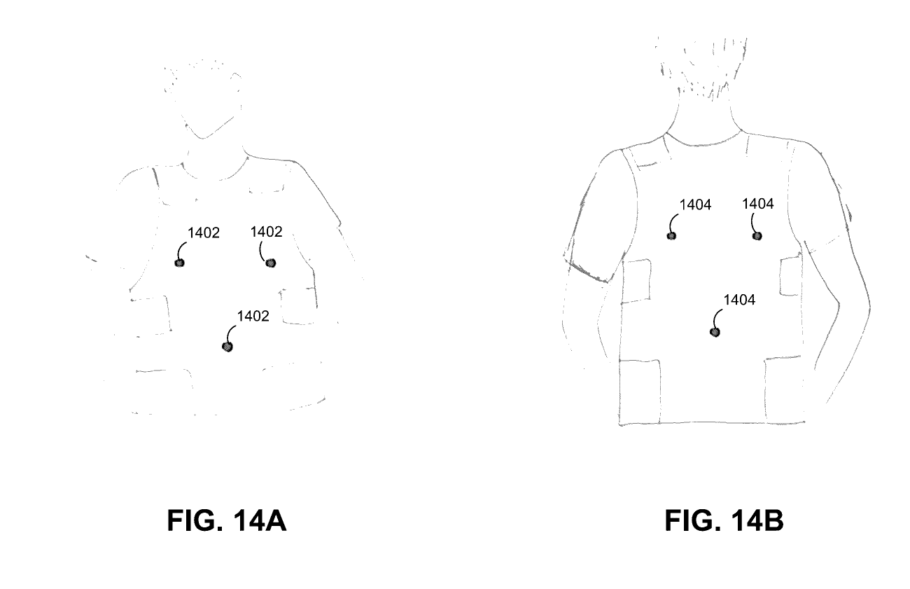

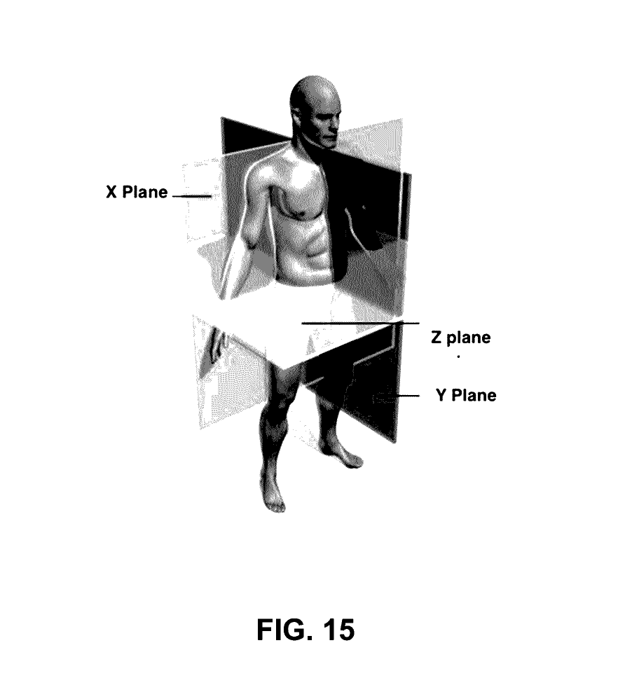

FIGS. 14A-14B show a vest having a total of 6 accelerometers attached to the inner layer of the vest. In the present embodiment, each face of the vest (i.e. the front face accelerometers 1402 shown in FIG. 14A and back face accelerometers 1404 shown in FIG. 14B) may have three accelerometers. In some embodiments, there may be fewer than three accelerometers per face, while in some other embodiments, there may be more than three accelerometers. The accelerometers can sense vibrations and forces experienced by the vest by being bonded or attached to the vest. The force/acceleration can be sensed in by each accelerometer along three planes as shown in FIG. 15: Z-plane being the plane parallel to the ground, describing depth; Y-plane being the plane that is perpendicular to the ground, covering the front to back vertical plane relative to the person wearing the vest; and X-plane being the plane perpendicular to the ground and covering the left to right vertical plane.

Each of the 6 accelerometers shown in FIGS. 14A and 14B can measure the acceleration experienced along an axis that is orthogonal to each of the plains independently. Therefore with 6 accelerometers, 18 signals may simultaneously be generated at any given time. The three accelerometers on each face of the vest (front face and back face) may be arranged to form the vertices of a virtual triangle, providing the capability to sense differential forces between the three accelerometers to estimate (i.e. triangulate) the location of the applied force on the vest, based at least on the signal amplitude generated by each accelerometer and its known position. This can be used to determine the location of bullet impact on the vest, for example.

As shown in FIG. 5, a plurality of sensors (6 accelerometers as shown in FIGS. 14A-14B) can be connected to one or more sensor controller 512. The sensor controller can communicate independently with each accelerometer to obtain the acceleration experienced by the accelerometer. The sensor controllers can be microcontrollers or DSPs (digital signal processors) or any suitable processor 514 (hereinafter “microcontroller”) that can provide faster execution on complex mathematical operations (e.g. Fast Fourier Transform (FFT)).

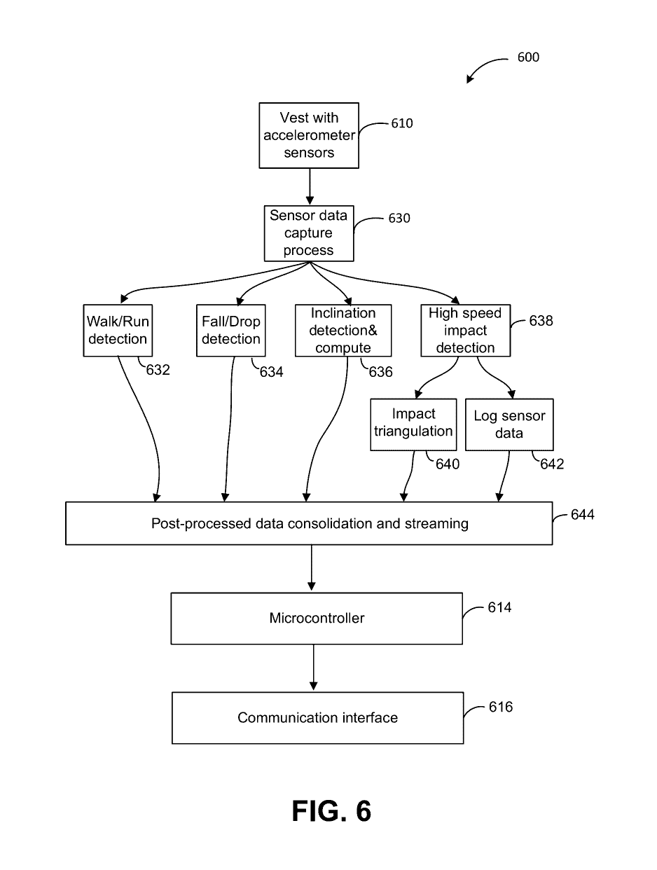

The sensor controller 512 can provide the collected data to the microcontroller 514 to determine whether an event of interest has occurred. In some embodiments, the data from the accelerometers 610 can be processed in parallel by the sensor controller 512 to perform near-simultaneously processing performance using multiple modules as shown in FIG. 6, to analyze what is being experienced by the vest and, the person wearing the vest.

Sensor data capture process module 630: As previously noted, there may be multiple channels of sensor data. In the case of 6 accelerometers as described previously, there may be 18 channels of incoming data (i.e. 3 axes times 6 accelerometers). The number of accelerometers or the number of channels can be increased or reduced to suit other configurations in other embodiments of the system.

The sensor data capture process module 630 may be operated to constantly capture data from accelerometer sensors 610 and store the data it in a memory buffer (not shown). In some implementations, a circular buffer may be used. In some embodiments, the last seconds of data (for example, from 1 to 10) can be stored in a data structure that is available for other modules to read and process. In some other embodiments, the data can be stored in a static memory location and the data is constantly overwritten, keeping only the last 1-10 seconds of data captured by all the sensors.

Walk/Run detection module 632: This module may be operated to function as a pedometer. It may take signals from the accelerometers and detect walking and running actions based on variations in the captured acceleration values.

Fall/Drop detection module 634: This module can be operated to detect sudden changes in acceleration. In particular, an event of interest may be identified if the detected magnitude of change in acceleration from at least 4 sensors are equal and originate from the same plane (total number of sensors per face+1). This condition can be used to indicate that the vest as a whole has experienced an event with similar intensity on both the back and front faces, for example, when the vest falls or is thrown onto the ground. This fall/drop detection module 634 can be used to rule out false readings when, for example, if an impact reported by the high-speed detection module 638 (see below) is in fact associated with vest being removed and thrown onto the floor which can be identified by the fall/drop detection module 634. Additionally, this module can also be used to detect when the user wearing the vest has fallen to the ground.

Inclination detection and compute module 636: This module may take signals from all of the accelerometers and compute the angle of inclination of the vest with reference to any of the X-Y-Z planes (forward and side inclination) using appropriate calculations. In some cases the angle may be determined through an inverse trigonometric function for each pair of planes (e.g., sin(θ)=y/\sqrt{x²+y²}). This module can be used to detect if the user has fallen to the ground, or if the vest is in storage and not being used (e.g. by detecting the lack of changes in inclination).

High Speed Impact detection module 638: During operation, this module may use the accelerometer signals corresponding to the Z-axis, since such signals can be used to determine depth acceleration. In a preferred embodiment, the accelerometers can be installed in the vest such that the Z-axis faces the user. The outputs of the accelerometers can be similarly filtered with a high pass filter and a DC removal filter. Short duration and high magnitude variations in the output signals can be detected by the module to indicate a a high speed impact to the vest. For example, such high speed impacts can include a punch or a bullet hit. When output signals corresponding to a high speed impact is detected, the module can also additionally compare the Z axis accelerations from all sensors to determine which sensor experienced the highest intensity impact so as to permit estimation of the location of the impact. For example, techniques such as triangulation used within an impact triangulation module 640 based on readings from all of the accelerometers can be used for impact localization estimates.

The high speed impact detection module 638 can detect events of interest when the Z-axis acceleration readings from the accelerometers on one face (for example, the front) are higher than those from the accelerometers on the other face (for example, the back), which indicates the bullet hit either on the front or on the back, but not simultaneously on both front and back. If high acceleration is detected on both the front and the back faces of the vest, it may mean that the person wearing the vest fell or experienced another non bullet hit event, which can be detected or confirmed by the Fall/Drop detection module 634 previously described.

If the high speed impact detection module 638 indicates an impact (e.g. outputting a Boolean “true” signal), an additional process, log sensor data 642, can be enabled to provide close monitoring of the situation by a remote station/agent via a remote device such as the remote computing device 106 of

FIG. 1. For example, if the user has been hit by a bullet, and then if he/she is walking, running, lying down, standing, etc., data from the accelerometers can help the remote station/agent understand the status of the user, in particular under situations where voice or human initiated communication is not available.

Data consolidation and streaming module 644: The data consolidation and streaming module may be configured to accept outputs from the various sensors described above for processing to determine the type of event (e.g. fall/drop, running, impact etc.) being experienced by the vest 610 and/or the user of the vest. For example, in some embodiments, each of the above identified modules can be operating simultaneously to determine the occurrence of an event that the respective module is configured to detect (e.g. walk/run, fall/drop, inclination etc.). The output of each module may provide a Boolean logic signal, such as a binary signal using “1” for true and “0” for false, to indicate to the data consolidation and streaming module 644 whether an event has occurred. For example, if the user is walking or running, the walk/run detection module 632 may set its output to “1”.

In some embodiments, while all of the modules may be operating to provide its signal to the data consolidation and streaming module 644, not all of the modules may be able to trigger an alert. In some cases, only the high impact speed detection module 680 may be able trigger an alert to be sent through the communication interface 616, and from there on, the data from all the other modules can be transmitted to complement the event information. For example, an impact indicative of a bullet impact may be sensed by the high speed impact detection module 638 so an alert can be generated by the microcontroller 614. Also provided to the microcontroller 614 (and subsequently to a host computing device) may include the data of the other modules to provide a full picture of the circumstances of the event.

In some embodiments, the manner in which an alert is triggered may be altered so that the high speed impact detection module 638 may not necessarily be the only module capable of triggering the alert to be sent through the communication interface 616. For example, in some embodiments, relying on the high speed impact detection block 638 to trigger an alert may be a default setting or rule. A system administrator may change this default rule for triggering an alert. In some cases, the rule may be changed so that receiving a positive detection signal (e.g. logic “1”) from any of the modules may be sufficient to trigger an alert. In other cases, there may be an order of events that may have to be detected before an event is triggered. For example, an alert may be triggered only if the following actions are detected in order: high speed impact, declination and fall, which requires a logic “1” signal first from the high speed impact detection module 638, then the inclination detection and compute module 636 and then the fall/drop detection module 634.

In some other embodiments, additional processing may be performed including time stamping, data compression and/or data encapsulation (i.e. creation of data packages in a suitable format).

Depending on the outcome of the sensor data analysis performed by the various modules described above, the data consolidation and streaming module 644 may be enabled to communicate relevant information to the remote computing device 106. All of the output from the various modules (movement, walking, running, high speed impact, inclination, etc.) can be used to assemble a data payload that can be passed to the microcontroller 614 for analysis. If an event of interest is determined, an alert along with the data payload can be transmitted via short range communications using communication interface 616 to a remote device such as the host computing device 104 of FIG. 1. The host computing device 104 can be a smartphone or radio that can further relay the information to a wider area network 108 so that the information can be further analyzed and appropriate actions taken.

In some embodiments, when the information is received by, for example, a monitoring station, a feedback signal can be communicated to the user, for example, by an auditory signal (e.g., “beep” sound) or visual signal (e.g. flashing lights) or haptic signal (e.g. vibration), generated by the host computing device so that the user can be informed that someone is aware of the situation and help may be on the way.

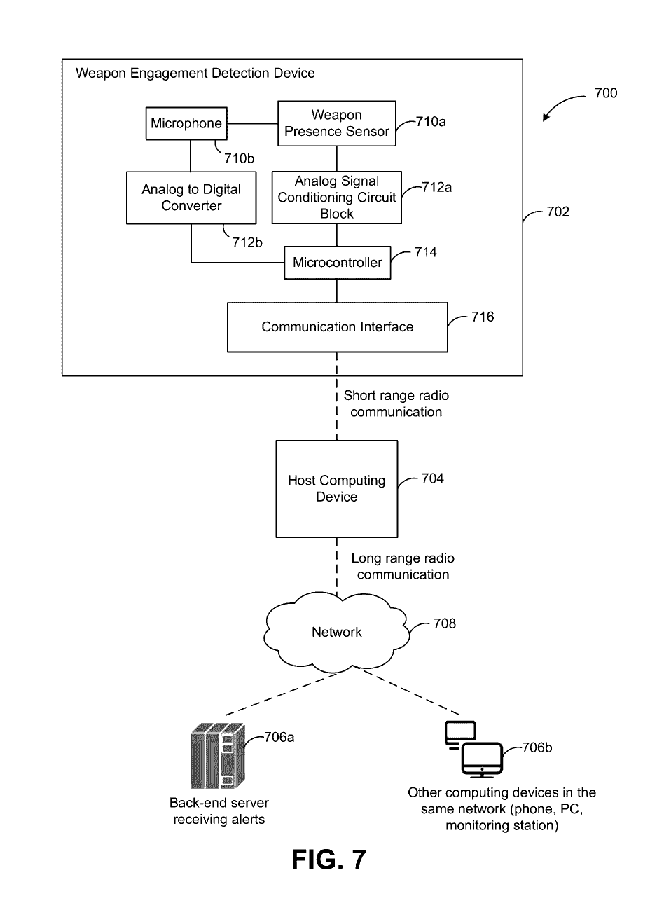

FIG. 7 illustrates another example embodiment of the personal emergency alert system 700 comprising a weapon engagement detection device 702 capable of detecting weapon draw and/or engagement. Weapons for the purpose of this disclosure can include, but not limited to, items that may inflict bodily harm of physical damage such as guns, batons and electroshock devices (i.e. Taser). The present embodiment can be used by police, army, or other peace keeping or law enforcement agents. The system 700 may be used to detect an event of weapon engagement (e.g., pistol draw or pull and shots fired) and automatically warn or notify remote parties 706a and/or 706b that a potential dangerous event involving the wearer of the weapon is taking place.

As shown in FIG. 7, the weapon engagement detection device 702 can comprise a weapon presence sensor 710a; a microphone 710b; a microcontroller 714; and a communication interface 716. Elements corresponding to those described previously shall be numbered in a similar manner.

In some embodiments, the weapon presence sensor 710a can be engaged or coupled or attached to the weapon's holder, holster, belt or any appropriate means for carrying or securing the weapon. In some embodiments, the weapon presence sensor 710a can detect the status of the weapon, for example, that the weapon is in place, removed, or re-inserted into its holder, by way of a magnetic switch (e.g. reed switch or hall-effect sensor). In some other embodiments, the weapon presence sensor 710a can detect the status of the weapon by way of a pressure switch.

In some embodiments, an amplifier may be present, for example, in the analog signal conditioning circuit block 712a to condition the signal produced from the weapon presence sensor 710a before it is provided to the microcontroller 714. The microcontroller 714 can analyze the input signal and generate an output signal indicating a weapon-related event such as weapon being drawn/pulled/removed from its holder, based on the detected status of the weapon. The output signal of the microcontroller 714 can then be relayed to remote parties 706a and 706b through the communication interface 716 and the host computing device 704. The microphone 710b can be activated when the weapon presence sensor 710a is activated (e.g. when the sensor 710a detects a change in the weapon's status). The microphone 710b can be configured to detect high intensity and short duration sounds resembling that of a gunshot.

In some embodiments, there can be an analog to digital converter 712b to convert the audio signal from the microphone before it is provided to the microcontroller 714. The microcontroller 714 can process the audio signal from the microphone and determine if the detected sound originated from a gun being discharged. In some embodiments, the microcontroller 714 can implement a discrete filter to isolate background noise from the sound of a potential close-range gunshot. In the present context, sensor signals corresponding to low speed movement of the user may be regarded as background noise. A high slope or high order high-pass filter may be used to discard such low-frequency noise. If the microcontroller 714 determines that the detected sound corresponds to a gunshot, it can be presumed that a gun has been fired or discharged, so the microcontroller can also relay information regarding the event to remote parties 706a and 706b through the communication interface.

In some embodiments, the communication interface 716 can use a standard communication protocol, for example, Bluetooth LE, WiFi, infrared or ultrasound, to communicate low power/low range signals. The communication interface can be configured to first accept the output from the microcontroller. If the output from the microcontroller 714 indicates a positive event of weapon engagement, for example, a weapon draw/pull/removal from its holder or a gunshot, the communication interface 716 can activate its signal transmission components to communicate the occurrence of the weapon engagement event to a host computing device 704 that is capable of long range communication (e.g., a tablet computer or smartphone that is connected to the Internet, or an RF radio carried by the wearer, typically a police officer or military personnel). The host computing device 704 can then warn/notify remote parties 706a and 706b of the occurrence of the weapon engagement event.

Remote parties 706a and 706b designated to receive such warning/notification can be pre-selected individuals or entities with their contact information pre-defined in a communication system by the wearer of the weapon engagement detection device. Remote parties 706a and 706b can also be a monitoring center affiliated with the police, army, or any other security entity monitoring the wearer of the weapon engagement detection device 702. In a preferred embodiment, the detection of a weapon engagement event and relaying of the information through the communication interface 716 and to remote parties 706a and 706b can be performed in real-time.

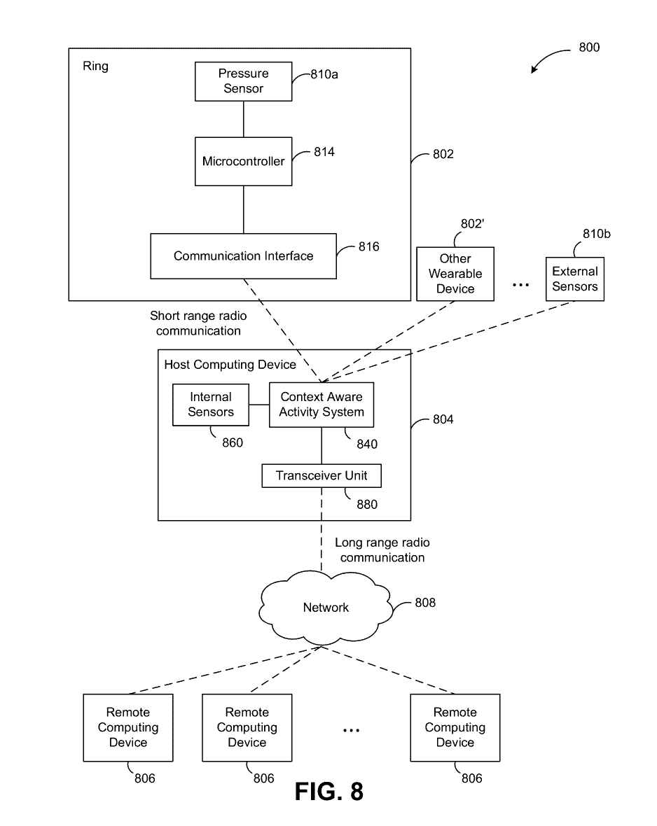

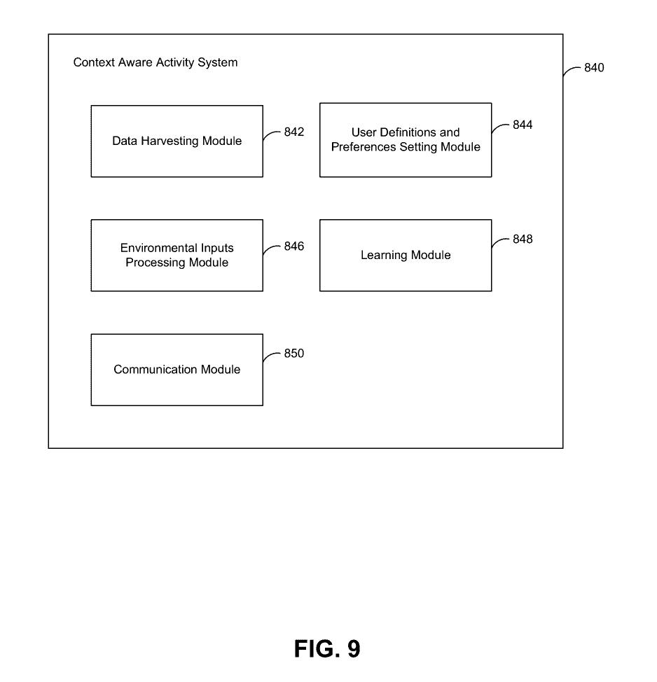

Reference is now made to FIG. 8, which shows a block diagram of components interacting as part of a context aware activity system 840 in accordance with an example embodiment. The wearable device in this example embodiment is a ring 802, although it may be contemplated that any other suitable wearable device may similarly be used. In the present embodiment, a context aware activity system 840, internal sensors 860 and a transceiver 880 is provided in the computing device 804. FIG. 9 provides more details with respect to the context aware activity system 840 of this embodiment. Elements corresponding to those described previously shall be numbered in a similar manner.

In some embodiments, the context aware activity system 840 can be a software application that can be installed in the host computing device 804 such as a smartphone. The context aware activity system 840 can take inputs from one or more internal sensors 860 taken during various activities engaged by the user (e.g., time, location, speed, preceding events and habits), and learn about the user's habits over time and predict what activity should automatically be done for the user. Such information may be used by the context aware activity system 840 to determine, over time, the activities being performed, and the context under which they were performed. Furthermore the context aware activity system 840 can receive inputs from external sources including wearable devices such as the ring 802 or other wearable devices 802′ and/or sensors 810b that are located near the host computing device, via short range radio communication. In some embodiments, external sensors 810(b) may include additional accelerometers to provide greater accuracy of impact detection and localization. For example, if the accelerometers are on a vest or in ring 802, they may better detect impacts on the chest and hand, respectively. While the host computing device 804 may include accelerometers, its location may prevent accelerometers built into the host computing device 804 from being exposed to the same forces impacting the chest and hand if the device is located in another part of the body or located somewhere away from the body. For example, the host computing device 804 may be a smartphone located in a purse or pocket away from the chest or hand. Consequently, the smartphone is unlikely to experience the same forces as the chest or the hand.

The context aware activity system 840 can make decisions based on the various inputs from the internal sensors 860, wearable device 802 and 802′ and/or external sensors 810b about controlling, via long range radio communication, one or more predefined remote devices over the network 808 by the host computing device 804, to automatically perform one or more predefined tasks. For example such tasks may include to engage or disengage a lock (e.g. a door lock, a safe etc.), open a garage door, send text messages with greetings, change the volume of a speaker, request and download data from a server, and/or post predefined messages on social media.

In a preferred embodiment, the context aware activity system 840 can be operated continuously collect information about the user's environment. The context aware activity system 840 can then analyze the data it has collected at a particular moment and generate a decision on what is the next action that the user is most likely to engage in, which can be an action that either has been predetermined by the user or is based on a decision reached by machine learning algorithms.

For example, when the user is arriving home from work, the next logical action may be to open the garage door if the user is driving, which can be determined based on the speed of the user. For instance, the context aware system 840 may identify that the user is traveling at a speed that is greater than his /her normal walking speed, that the time is late afternoon on a weekday and the user is near his/her home. Thus it is likely that the user is returning home from work. The next action that the user would most likely take is to activate the garage door upon pulling up to the driveway. Therefore the context aware activity system 804 may generate a command to the garage door at the appropriate time (i.e. when the user is driving into the drive way) to activate the garage door.

Also in a preferred embodiment, any task to be automatically performed can be confirmed by the user on a wearable device worn by the user, before the task is performed. In the garage door example above, the garage door would not be opened automatically, but only as a result of a confirmation process triggered by the user of the wearable device. For example, as shown in FIG. 8, the wearable device can be a ring 802 comprising a touch enabled sensor 810a, a microcontroller 814, and a communication interface 816. To confirm opening of the garage door, the touch enabled sensor 810a can generate a signal as a result of, for example, a light tap on the ring by the user. The signal can then be processed by the microcontroller 814 and transmitted, as confirmation by the user to perform the task, through the communication interface 816 over short range radio communication to the context aware activity notification software installed on the host computing device 804. In turn, the host computing device may examine a set of ranked rules, as described in more detail below, to infer and decide on the most appropriate action to perform. For example, when the user presses the button with the intent of opening its garage door, the host computing device 804 may identify this intent by checking if the user is arriving home and if the current GPS location matches the known location of the user's home. Upon determining that the user is arriving home, a command to open the garage door may be transmitted by the transceiver unit 880 via long range radio communication over network 808 to remote computing device. In the present case the remote computing device 806 may be the garage door which is wirelessly connected to the network 808 to receive commands. Since actions such as opening the garage door can inferred, the user may not need to receive a prompt to confirm opening of the garage door. The host computing device can determine the user's desire/intent based on the context in which the button was pressed.

In some embodiments the host computing device may establish window or time-out for expecting an input. For example, in the case of the garage door, a time-out of 60 seconds or any appropriate time interval may be set.

FIG. 9 provides more details on an example implementation of the context aware activity notification software in accordance with at least one embodiment. In the present embodiment, the context aware activity notification software can be operated on a smartphone. In other embodiments, the software may be operated on a tablet device, or another wearable device such as a smart watch. In the present embodiment, the context aware activity system comprises a Data Harvesting Module 842, a User Definition and Preference Setting Module 844, an Environment Inputs Processing Module 846, a Learning Module 848, and a Communication Module 850.

The Data Harvesting Module 842 can capture environmental variables, including but not limited to: GPS location (e.g., sampled periodically, for instance, at a desired frequency which can range from once every few seconds to once every 15 minutes or more), speed, recent phone calls, proximity to work, proximity to home, proximity to a friend's house, proximity to a specific address, proximity to other predefined devices, detection of WIFI networks, detection of Bluetooth devices, weather information, calendar events such as vacations, meetings, trip information events, social media activity, and other events that can be detected by a mobile device, such as movement, acceleration, battery level, time of day, date, etc. All of the information can be stored on a local database component (not shown) and may or may not be transferred to another device over a network such as the Internet or a private network. The Data Harvesting Module 842 can further be configured to classify the collected data into different categories to allow easy retrieval of the collected data by the user at a later time.

Through the User Definition and Preferences Setting Module 844, the user can define devices that may be controlled by the context aware activity system and conditional activities in which the devices may be operated, i.e., activities to perform if certain conditions are satisfied, for example, “if I am leaving work, open the garage door after a button is pressed on my wearable device”. In an example embodiment, such a conditional activity can be stored in a database as an activity (e.g., open the garage door) linked with one or more conditions (e.g., condition 1: I am leaving work; condition 2: a button is pressed on a wearable device).

In some embodiments, the user can additionally define one or more such conditions or rules, and one or more such conditional activities, based on the types or categories of data being collected. Furthermore, a list of actionable items can be generated beforehand or in real-time based on the collected data, for the user to choose from. For example, speed and location data may indicate the condition “I am leaving work” is satisfied. In that case, this module may generate an activity “open the garage door” to present to the user and wait for the user to confirm action. Functionality of the remote device can also be taken into account, for example, if the user's garage door can be controlled by a command sent over a network.

The Environment Inputs Processing Module 846 can execute a rules matching algorithm that, in real-time, monitors data collected by the Data Harvesting Module 842, examines a database of user defined conditions or rules and assigns each with a score based on its proximity to the data collected, and, when the user confirms action on the wearable device, performs the action associated with the highest ranked combination of rules or conditions.

In an example embodiment, the stored conditional activity may be: if I am leaving work, if I am driving, and if I am 500 m from home, open the garage door. Speed data may indicate the condition “I am driving” is satisfied, so that the environment inputs processing module 846 may assign the highest rank to this condition. Location data may indicate the condition “I am leaving work” is satisfied, so this condition may similarly be given the highest rank to this condition. Alternatively, location data may further indicate that the user is near his or her home, for example, 1 km from home, in which case the “I am 500 m from home” condition is not satisfied. However, a ranking can still be assigned to the location data based on the likelihood of a condition being met. For example a ranking that is assigned if the user is 1 km from his or her home can be higher than a ranking given if the user was 2 km from his or her home.

The rankings of the conditions can be considered separately or together to determine a rank for the conditional activity. For example, if the conditional activity “open garage door” is the highest ranked activity on a list of other possible conditional activities, then a user confirmation signal received from a wearable device can trigger the garage door to open. This can give the user flexibility in performing the action to open garage door, even if not all the conditions have been met. User confirmation on the wearable device, as described above for example, light tapping on the ring 802 of FIG. 8, has the role of providing a shortcut to confirm/trigger an action without having to look at the smartphone, or opening an application on it.

In some embodiments, the user or an administrator may specify preferred rankings over what may be determined automatically by the host computing device. Using again the garage door example, the user or system administrator may specify that a conditional activity “unlock main door” should rank higher than “open garage door”. A user may prefer to do this, for example, if the user does not wish to park the car inside the garage but prefers to park the car on the driveway. As a result, a user's confirmation via the press of a button of the wearable device may trigger the main door to unlock rather than cause the garage door to open.

Initially or over time the system may not always trigger the correct action(s). This can be due to a number of reasons, such as insufficient information or two different conditional activities or scenarios involving similar environmental data or similar conditions. For example, when the user arrives home by car, the action to “open garage door” and “unlock main door” may be equally or similarly ranked as possible actions. In this case the user may take the opportunity to “teach” the system with respect to the user's intent (either open garage first or unlock main door first). For example the user may manually trigger the main door to unlock rather than opening the garage door. This way, the context aware activity system 840 may learn the user's preference and priorities when particular “environmental conditions” (e.g. GPS location, speed of movement) are present. In such cases, the user can access a user interface of the context aware activity notification software on the smartphone to input whether the activity executed was correct or incorrect. This input, along with the environmental data associated with the wrongly triggered action, can be recorded into a knowledge base and feed a predictive algorithm to help improve accuracy in future scoring of activities. The user interface, the knowledge base, and the predictive algorithm are all components of the Learning Module 848.

Once the context aware activity system receives user confirmation to perform an action, the Communication Module 850 can determine whether a command to perform the action should be transmitted to the corresponding remote device(s), often through the built-in transceiver such as the transceiver unit 880 of FIG. 8 of the smartphone over the Internet or a private network. In some embodiments, the decision is partly based on the network readiness or networking capabilities of the remote device.

For example, a network ready garage door may have the capability to be remotely controlled by a smartphone; a network ready camera may be able to receive a command through the Internet to take a picture. Networking capabilities may include popular Internet applications, for example, sending an email, posting on social networks, sending a text message, and attaching information from the data harvesting module such as location, direction, etc. For example, when a person is approaching home from the airport, the context aware activity system can send a text to the person's partner announcing the person is returning home.

In view of the preceding discussions of the various embodiments of the wearable devices, it may be noted that the wearable device may require a power source to provide power to operate of the various hardware components. As such, the usefulness of the wearable device may depend at least in part on the capacity of the power source to provide power. In some embodiments, the power source may be provided by a single-use battery or a rechargeable battery or any other appropriate power source. In other embodiments, then power may be harvested using, for example, piezoelectric devices based on movement of the wearer to at least partially recharge a battery. It may be appreciated that reduction of power consumption of the various electrical components is advantageous since the battery life can be extended so that the usefulness of the wearable device may be also extended.

Referring back to FIG. 1, wearable device 102 may be battery-powered. The communication interface 116 used to generate radio transmissions to communicate any desired data including messages or events to the remote computing device 104 may quickly deplete the battery. Therefore, one way to extend the battery life is to minimize the use of the transmission components of the communication interface 116. In some embodiments, it may be preferable to enable radio transmission features upon detection of a “wake” event. Such a wake event can be a personal emergency alert being triggered in response to, for example, a button press by a user, acceleration levels (i.e. those corresponding to a fall or an impact), impact, speed, orientation changes, vibration or other physical events based on the signals generated by the appropriate sensors installed in the wearable device. As such, the communication interface 116 during its normal state may be placed in a power saving mode where there is no active data transmission.

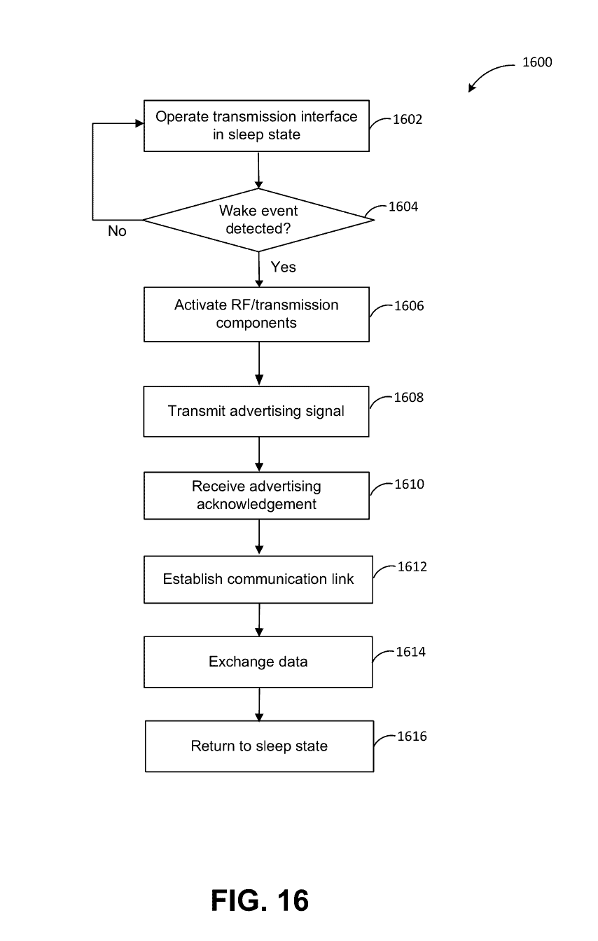

FIG. 16 is a flowchart showing the steps of method 1600 for optimizing the battery life of a wearable device of emergency alert system in accordance to at least one embodiment. The wearable device 102 of FIG. 1 shall be used to facilitate description of method 1600. At step 1602 the communication interface 116 may be operated in a “sleep” state, in which the radio and RF circuitry such as the transmitting and receiving circuit components of the communication interface 116 is off. The circuitry may be minimally powered so that the communication interface 116 detect a wake event, as described above, and wake from the sleep state.

At step 1604, if a wake event of interest is detected, for example, based on the outputs of the sensors 110a and 110b, the radio/transmitting component of the communication interface 116 may be activated at step 1606. Otherwise, the communication interface 116 remains in the sleep state according to step 1602.

At step 1608, the activated communication interface 116 may transmit an advertising signal in accordance with the communication protocol in use (e.g. Bluetooth, ANT, Zigbee etc.). This advertising event may be detected by a nearby device such as the host computing device 104. The host computing device 104 may acknowledge the advertising signal, in step 1610, in a handshake procedure which may include sending an acknowledgement signal back to the communication interface 116. At step 1612 a communication link with the host computing device 104 and the communication interface 116 is established. Subsequently at step 1614, the desired data may be exchanged between the two devices. For example, data sensed by the sensors 110a may be transmitted wirelessly by the communication interface 116 to the host computing device 104. At step 1616, communication interface 116 reverts back to the sleep state upon completion of the data exchange.

Since the power consuming portion of the communication interface 116 is normally off, such an arrangement means that use of circuit components which consume the highest power can be minimized to help extend the life of the battery or allow smaller batteries to be used, allowing the wearable device to be even more compact.

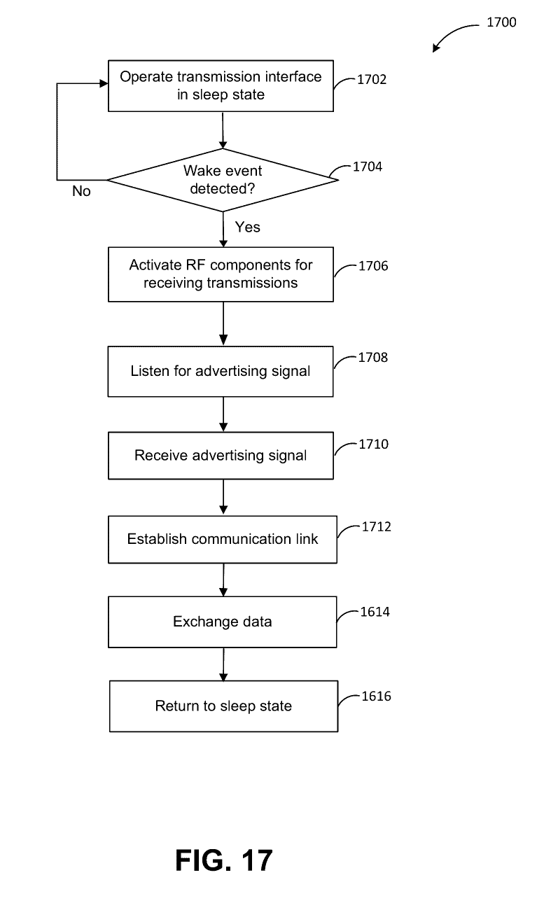

FIG. 17 is a flowchart showing the steps of method 1700 for optimizing the battery life of a wearable device of a personal emergency alert system in accordance to another embodiment. The wearable device 102 of FIG. 1 shall be used to facilitate description of method 1700. Similar to step 1902 above, at step 1702, the communication interface 116 may be operated in a “sleep” state, in which the radio and RF circuitry of the communication interface 116 is off. The circuitry may be minimally powered so that the communication interface 116 detect a wake event, as described above, and wake from the sleep state.

At step 1704, if a wake event of interest is detected, for example, based on the outputs of the sensors 110a and 110b, a portion of the radio components of the communication interface 116 associated with receiving wireless transmissions may be activated at step 1706. Otherwise, the communication interface 116 remains in the sleep state according to step 1702.

At step 1708, upon activation of the radio circuit components associated with receiving transmissions, the communication interface 116 is operated to “listen” for an advertising transmission from a remote device such as the host computing device 104. It may be noted that this step is different from step 1606 of FIG. 16 in which transmission of the advertisement signal is provided by the communication interface 116.

At step 1710, the communication interface 116 receives an advertising transmission from the host computing device 104. At step 1712, RF transmission components may be activated to establish a communication link. Subsequently at step 1714, data may be exchanged between the two devices. For example, data sensed by the sensors 110a may be transmitted wirelessly by the communication interface 116 to the host computing device 104. At step 1716, communication interface 116 reverts back to the sleep state upon completion of the data exchange.

It can be noted that in the power optimization method described in FIG. 17, the power consumption can be further reduced compared to the power optimization method of FIG. 16 because it is generally the case that more power is needed transmit a wireless signal than it is to receive a signal. By further reducing the amount RF transmissions made by the communication interface 116 when it is activated, even less power is consumed. The additional power savings may be thereby further extending the life of the battery.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A method for providing a personal emergency signal to a remote computing device from a wearable device having at least one sensor, a microcontroller, and a communication interface, via a host computing device, the method comprising:
receiving at the wearable device at least one sensor input signal from the at least one sensor;
executing a plurality of computer instructions using the microcontroller to:
(i) process the at least one sensor input signal; and
(ii) determine whether a personal emergency event has occurred, and, if so, generate the personal emergency signal;
operating the microcontroller to transmit the personal emergency signal through the communication interface to the host computing device using a first communication link; and
operating the host computing device to transmit the personal emergency signal to the remote computing device using a second communication link.

2. The method of claim 1, wherein
the wearable device is a bullet proof vest; and
the at least one sensor input signal is a sensor input signal from a resistive sensor installed within the bullet proof vest.

3. The method of claim 2, further comprising:
providing the sensor input signal to an analog signal conditioning circuit block to produce a conditioned sensor input signal;
providing the conditioned sensor input signal to an analog to digital converter to produce a digitized sensor input signal;
generating a filtered sensor input signal by:
providing the digitized sensor input signal to a first filter , wherein the first digital filter is configured to perform DC removal and signal inversion; and
providing the digital sensor input signal to a second digital filter, wherein the second digital filter is configured to perform low level signal attenuation, zero crossing detection, and amplification of short lived signal values on the digital sensor input signal; and
operating a threshold detection module to generate the personal emergency signal upon determining that at least one portion of a signal amplitude associated with filtered sensor input exceeds a predefined threshold value.

4. The method of claim 1, wherein
the wearable device is a bullet proof vest; and
the at least one sensor input signal comprises a plurality of sensor input signals generated by a plurality of accelerometers installed at a plurality of locations within the bullet proof vest.

5. The method of claim 4, further comprising:
providing the plurality of sensor input signals to at least one sensor controller to obtain a plurality of acceleration values, wherein each acceleration value corresponds to an acceleration experienced by each of the plurality of accelerometers; and
providing the plurality of acceleration values to the microcontroller to determine whether a personal emergency event has occurred, and, if so, generate the personal emergency signal.

6. The method of claim 1, wherein
the wearable device is a weapon engagement detection device; and
the at least one sensor input signal comprises a first sensor input signal from a weapon presence sensor operatively coupled to a weapon holder and a second sensor input signal from a microphone.

7. The method of claim 6, further comprising
providing the first sensor input signal to an analog signal conditioning circuit block to generate a conditioned first sensor input signal; and
providing the conditioned first sensor input signal to the microcontroller to determine whether a personal emergency event has occurred, and, if so, generate the personal emergency signal.

8. The method of claim 6, further comprising
activating the microphone if the weapon presence sensor is activated;
providing the second sensor input signal to an analog to digital converter to generate a digitized second sensor input signal; and
providing the digitized sensor input signal to the microcontroller to determine if the digital sensor input signal corresponds to the sound of a gunshot, and, if so, generate the personal emergency signal.

9. The method of claim 1, wherein the communication interface comprises at least a transmitting circuit component and a receiving circuit component, each of which being normally disconnected from an electrical power source so as to be in a sleep state.

10. The method of claim 9, further comprising
connecting the electrical power source to the transmitting circuit component and the receiving circuit component to put both circuit components to a wake state;
operating the transmitting circuit component to transmit an advertising signal to the host computing device;
establishing the first communication link with the host computing device to exchange a desired data between the wearable device and the host computing device upon receiving an acknowledgement signal by the receiving circuit component; and
disconnecting the electrical power source, after exchanging the desired of data, to revert the transmitting circuit component and receiving circuit component from the wake state to the sleep state;

11. The method of claim 9, further comprising
connecting the electrical power source to the receiving circuit component to put the receiving circuit component to a wake state;
operating the receiving circuit component to receive an advertising signal from the host computing device;
connecting the electrical power source to the transmitting circuit component to the wake state upon receiving the advertising signal;
establishing the first communication link with the host computing device to exchange a desired data between the wearable device and the host computing device; and
disconnecting the electrical power source, after exchanging the desired data, to revert the transmitting circuit component and receiving circuit component from the wake state to the sleep state;

12. A method for providing a context aware activity notification to a remote computing device upon receiving an activity confirmation signal from a wearable device, the method comprising:
providing a context aware activity notification software for installation on a host computing device, the context aware activity notification software comprising:
a data harvesting module to receive a plurality of environmental inputs from a plurality of sensors;
a user definition and preferences setting module to receive input from a user to define and store in a memory a plurality of conditional activities, wherein each conditional activity comprises an activity, at least one condition associated with the activity, and a link to a remote computing device to perform the activity;
an environmental input processing module to monitor the plurality of environmental inputs by performing at least a rules matching process, wherein the process comprises at least the steps of ranking the plurality of conditional activities, assigning and storing in the memory a first rank for each conditional activity, based on a comparison of the at least one condition associated with the activity and the plurality of environmental inputs;
a learning module configured to
receive user input that ranks a subset of conditional activities in the plurality of conditional activities;
assign and store in the memory a second rank for each conditional activity in the subset of conditional activities based on user input; and
store in a knowledge base the conditional activity in connection with the first rank and the second rank when the ranking of conditional activities of the second rank is different from those of the first rank; and
a communication module configured to
receive an activity confirmation signal from the wearable device;
sort the plurality of conditional activities based on rank;
generate a context aware activity notification message based on the conditional activity with the highest rank; and
transmit the context aware activity notification message to the remote computing device associated with the conditional activity with the highest rank, wherein the context aware activity notification message instructs the remote computing device to perform the conditional activity with the highest rank.

13. The method in claim 12, wherein the wearable device is a ring comprising a touch enabled sensor, a microcontroller, and a communication interface, wherein the microcontroller receives a sensor input signal from the touch enabled sensor and provides an activity confirmation signal for transmission by the communication interface to the host computing device.

14. A personal emergency alert system, the system comprising:
a wearable device with at least one sensor, a microcontroller, and a communication interface;
a host computing device; and
a remote computing device;
wherein
the wearable device receives at least one sensor input signal from the at least one sensor;
the microcontroller executes a plurality of computer instructions to:
(i) process the at least one sensor input signal; and
(ii) determine whether a personal emergency event has occurred, and, if so, generate a personal emergency signal for transmission by the communication interface to the host computing device using a first communication link; and
the host computing device sends the personal emergency signal to the remote computing device using a second communication link.

15. The system of claim 14, wherein
the wearable device is a bullet proof vest; and
the at least one sensor input signal is a signal generated by a resistive sensor installed within the bullet proof vest.

16. The system of claim 15, further comprising:
an analog signal conditioning circuit block to condition to generate a conditioned sensor input signal;
an analog to digital converter to convert the conditioned sensor input signal to a digitized sensor input signal;
a filtering module to produce a filtered sensor input signal comprising
a first filter configured to perform DC removal and signal inversion;
and
a second filter configured to perform low level signal attenuation, zero crossing detection, and amplification of short lived signal values on the digital sensor input signal from the first filter module; and
a threshold detection module to generate the personal emergency signal upon determining that at least one portion of a signal amplitude associated with filtered sensor input exceeds a predefined threshold value.

17. The system of claim 14, wherein
the wearable device is a bullet proof vest; and
the at least one sensor input signal comprises a plurality of sensor input signals generated by a plurality of accelerometers installed at a plurality of locations within the bullet proof vest.

18. The system of claim 17, further comprising:
at least one sensor controller to receive a plurality of acceleration values, wherein each acceleration value corresponds to an acceleration experienced by each of the plurality of accelerometers; and
a microcontroller to execute a plurality of computer instructions to process the plurality of acceleration values to determine whether a personal emergency event has occurred, and, if so, generate a personal emergency signal.

19. The system of claim 14, wherein
the wearable device is a weapon engagement detection device;
the at least one sensor input signal comprises a first sensor input signal from a weapon presence sensor operatively coupled to a weapon holder and a second sensor input signal from a microphone; and
the microphone is activated if the weapon presence sensor is activated.

20. The system of claim 19, further comprising
an analog signal conditioning circuit block to generate a conditioned first sensor input signal; and
a microcontroller to receive the conditioned first sensor signal and generate a personal emergency output signal upon determining that a personal emergency has occurred.

21. The system of claim 19, further comprising
an analog to digital converter to generate a digitized second sensor input signal; and
a microcontroller to process the digitized sensor input signal to determine if the digital sensor input signal corresponds to the sound of a gunshot, and, if so, generate the personal emergency signal.

22. The system of claim 14, wherein the communication interface comprises at least a transmitting circuit component and a receiving circuit component, each of which being normally disconnected from an electrical power source so as to be in a sleep state.

23. The method of claim 22, further comprising
connecting the electrical power source to the transmitting circuit component and the receiving circuit component to put both circuit components to a wake state;
operating the transmitting circuit component to transmit an advertising signal to the host computing device;
establishing the first communication link with the host computing device to exchange a desired data between the wearable device and the host computing device upon receiving an acknowledgement signal by the receiving circuit component; and
disconnecting the electrical power source, after exchanging the desired of data, to revert the transmitting circuit component and receiving circuit component from the wake state to the sleep state;

24. The method of claim 22, further comprising
connecting the electrical power source to the receiving circuit component to put the receiving circuit component to a wake state;
operating the receiving circuit component to receive an advertising signal from the host computing device;
connecting the electrical power source to the transmitting circuit component to the wake state upon receiving the advertising signal;
establishing a communication link with the host computing device to exchange a desired data between the wearable device and the host computing device; and
disconnecting the electrical power source, after exchanging the desired data, to revert the transmitting circuit component and receiving circuit component from the wake state to the sleep state;

25. A context aware activity system, the system comprising:
a wearable device to receive input from a user and generate an activity confirmation signal;
a plurality of remote computing devices; and
a host computing device operating a context aware activity notification software, the context aware activity notification software comprising:
a data harvesting module to receive a plurality of environmental inputs from a plurality of sensors;
a user definition and preferences setting module to receive input from the user to define and store in a memory a plurality of conditional activities, wherein each conditional activity comprises an activity, at least one condition associated with the activity, and a link to a remote computing device to perform the activity;
an environmental input processing module to monitor the plurality of environmental inputs by performing at least a rules matching process, wherein the process comprises at least the steps of ranking the plurality of conditional activities, assigning and storing in the memory a first rank for each conditional activity, based on a comparison of the at least one condition associated with the activity and the plurality of environmental inputs;
a learning module configured to
receive user input that ranks a subset of conditional activities in the plurality of conditional activities;
assign and store in the memory a second rank for each conditional activity in the subset of conditional activities based on user input; and
store in a knowledge base the conditional activity in connection with the first rank and the second rank when the ranking of conditional activities of the second rank is different from those of the first rank; and
a communication module that
receive an activity confirmation signal from the wearable device;
sort the plurality of conditional activities based on rank;
generate a context aware activity notification message based on the conditional activity with the highest rank; and
transmit the context aware activity notification message to the remote computing device associated with the conditional activity with the highest rank, wherein the context aware activity notification message instructs the remote computing device to perform the conditional activity with the highest rank.

26. The system in claim 25, wherein the wearable device is a ring comprising a touch enabled sensor, a microcontroller, and a communication interface, wherein the microcontroller receives a sensor input signal from the touch enabled sensor and provides an activity confirmation signal for transmission by the communication interface to the host computing device.
